(19) United States
(12) Patent Application Publication
(10) Pub. No.: US 2017/0216947 A1
(43) Pub. Date: Aug. 3, 2017

(54) SYSTEMS AND METHODS FOR REINFORCED ADHESIVE BONDING

(71) Applicants: Xin YANG, Beijing (CN); GM GIobal Technology Operations LLC, Detroit, MI (US)

(72) Inventors: Yongqiang Li, Rochester Hills, MI (US); Blair E. Carlson, Ann Arbor, MI (US); Xin Yang, Beijing (CN); Jianfeng Wang, Nanjing, Jiangsu (CN)

(21) Appl. No.: 15/328,555

(22) PCT Filed: Jul. 28, 2014
(86) PCT No.: PCT/CN2014/083106

§ 371 Date: Jan. 24, 2017

(51) Int. Cl. B23K 3/06; B23K 1/00; B23K 35/02

(52) U.S. Cl. CPC B23K 3/0638; B23K 35/025; B23K 1/0008; B23K 2201/006

(57) ABSTRACT

A solder-reinforced bonding system comprises a first substrate (110), a second substrate (120) at least partially in contact with a heating element (400), an adhesive (200) in contact with a first contact surface (115) of the first substrate (110) and a second contact surface (125) of the second substrate (120), and a plurality of solder balls (300) positioned in the adhesive (200) in contact with the first contact surface (115) in a location to receive thermal energy from the heating element (400). A method of producing a solder-reinforced adhesive bond between a first substrate (110) and second substrate (120), comprises (i) applying an adhesive composite (250) including an adhesive (200) and a plurality of solder balls (300) on a first contact surface (115) of the first substrate (110), (ii) connecting a second contact surface (125) of the second substrate (120) to a portion of the adhesive composite (250) opposite the first contact surface (115), and (iii) applying thermal energy from a heating element (400).

### TECHNICAL FIELD

The present technology relates to adhesive bonding for substrate materials. More specifically, the technology provides reinforced adhesive bonding in various ways through the use of solder balls.

### BACKGROUND

Structural adhesives replace welds and mechanical fasteners in many applications because structural adhesives reduce fatigue and failure commonly found around welds and fasteners. Structural adhesives can also be preferable to welds and mechanical fasteners where resistance to flex and vibration is desired.

Adhesive bonding uses structural adhesives to connect a substrate surface of one material to another substrate surface of the same material or a different material. Adhesive bonding is widely used in applications in which materials with low bonding temperature are required or in applications requiring the absence of electric voltage and current. Additionally, adhesive bonding may help improve corrosion resistance through eliminating substrate material contact with fasteners and other corrosive elements.

When structural adhesives are applied to substrate surfaces, a bond line forms at the meeting of the substrate surfaces. Uniformity within the bond line is an important factor for optimal adhesive performance, thus dictating that bond line thickness is critical in designing a bond joint.

When substantial force exists, structural adhesives used in adhesive bonding may be loaded (1) normal to the bond line, which creates a peeling effect causing substrate materials to be on different planes (i.e., peel fracture), or (2) perpendicular to the leading edge of a fracture, whether in-plane or out-of-plane, which creates a shearing effect where substrate materials remain on the same plane (i.e., shear fracture). While fracturing is typically avoided, if there is to be fracturing, shear fracture is preferred over peel fracture because shear fracture requires an external loading that is greater than that of peel fracture to produce failure.

Adhesives by nature exhibit fluid-like characteristics for tacking substrates during bonding processes and solid characteristics (often known as cured adhesives) for sustaining load in a finished assembly. Curing of an adhesive can be either a process of physical transformation and/or chemical transformation that occurs during a definite period of time when physical or chemical energy exchange occurs within the adhesive or between the adhesive and the environment. During the period of energy exchange, external forces are required to hold the substrates and adhesive together before the adhesive cures and gains strength.

Unlike in a welded joint where metallic alloy bonds form between the substrates, a cured adhesive holds the substrates together via electro-static or van der Waals forces at the adhesive-substrate interfaces and polymer bonds within the adhesive. Since bondswithin adhesive joints may become unstable when subject to activation energy levels, adhesive joints are often complemented by welding and mechanical fasteners to achieve long term stability.

Resistive spot welding (RSW), a process, prior to curing, in which metal substrates are joined by heat from an electric current after the substrates are assembled with an adhesive. RSW can be used to promote structural stability between substrates during handling of an adhesive-bonded assembly, curing of the adhesive to gain bond strength, as well as during the use of the finished product. The amount of heat (energy) delivered to the spot is determined by the resistance between the electrodes and the magnitude and duration of the current. The heat required to fuse bond metals (e.g., steel and aluminum) can result in a high temperature that causes evaporation of the adhesive or chemical degradation of the adhesive.

### SUMMARY

A need exists for a structural adhesive that creates bond line uniformity and provides sufficient strength and stability during subsequent processing and usage.The present disclosure relates to systems and methods for establishing a structural adhesive that creates bond line uniformity and provides strength and dimensional stability until the structural adhesive cures during subsequent processing. Additionally, the present disclosure relates to methods to provide in-line process monitoring of the structural adhesive bondline.

In one aspect, the present technology includes a bonding system a first substrate, a second substrate at least partially in contact with a heating element, an adhesive in contact with a first contact surface of the first substrate and a second contact surface of the second substrate, and a plurality of solder balls positioned in the adhesive in contact with the first contact surface in a location to receive thermal energy from the heating element.

In some embodiments, the heating element produces thermal energy to a localized area of the second substrate.

In some embodiments, the plurality of solder balls bonds to the first substrate at a temperature conductive to thermal energy produced by the heating element.

In some embodiments, at least one of plurality of solder balls bonds to the first substrate at a temperature other than the thermal energy produced by the heating element.

In some embodiments, the plurality of solder balls are positioned in a distribution (i) arresting crack propagation or (ii) promoting crack propagation along a path) requiring the greatest amount of fracture energy.

In some embodiments, one or more of the plurality of solder balls are further positioned in contact with the second contact surface.

In another aspect, the present technology includes a bonding system comprising a first substrate, a second substrate at least partially in contact with a heating element, an adhesive in contact with a first contact surface of the first substrate and a second contact surface of the second substrate, and a plurality of solder balls of one or more bonding temperatures positioned throughout the adhesive in contact with the first contact surface at least one of the plurality of solder balls positioned to receive thermal energy from the heating element.

In some embodiments, the heating element produces thermal energy to a localized area of the second substrate.

In some embodiments, the plurality of solder balls bonds to the first substrate at a temperature conductive to thermal energy produced by the heating element.

In some embodiments, at least one of plurality of solder balls bonds to the first substrate at a temperature other than the thermal energy produced by the heating element.

In some embodiments, one or more of the plurality of solder balls are further positioned in contact with the second contact surface.

In yet another aspect, the present technology includes a bonding method to produce a solder-reinforced adhesive bond between a first substrate and second substrate, comprising (i) applying an adhesive composite including an adhesive and a plurality of solder balls on a first contact surface of the first substrate,such that at least one of the plurality of solder balls is in contact with the first contact surface, (ii) connecting a second contact surface of the second substrate to a portion of the adhesive composite opposite the first contact surface, and (iii) applying thermal energy from a heating element to a surface of the first substrate opposite the first contact surface, such that at least one of the plurality of solder balls reaches a solder-ball bonding temperature.

In some embodiments, the heating element produces thermal energy to a localized area of the second substrate, opposite the second contact surface.

In some embodiments, the plurality of solder balls bonds to the first contact surface or the second contact surface at a temperature conductive to thermal energy produced by the heating element.

In some embodiments, at least one of plurality of solder balls bonds to the first contact surface or the second contact surface at a temperature other than the thermal energy produced by the heating element.

Other aspects of the present technology will be in part apparent and in part pointed out hereinafter.

### DESCRIPTION OF THE DRAWINGS

FIG. 1 illustrates a side view of a bonding system with solder balls concentrated under a localized heating element.

FIG. 2 illustrates a side view of a bonding system with solder balls distributed throughout the bondline.

FIG. 3 illustrates an exploded perspective view of the exemplary embodiment of FIG. 2 containing solder balls with a random distribution and a localized heating element.

FIG. 4 is a flow chart a flow chart illustrating methods associated with a distribution sequence and resistance sequence.

FIG. 5 illustrates an exemplary embodiment of distribution sequence in FIG. 4.

FIG. 6 illustrates an exemplary embodiment of resistance sequence in FIG. 4.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., descriptions of multiple components described herein in connection with one or more functions are to be interpreted to cover embodiments in which a single component performs the function(s).

In some instances, well-known components, systems, materials, or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

While the present technology is described primarily in connection with manufacturing components of a vehicle in the form of an automobile, it is contemplated that the technology can be implemented in connection with manufacturing components of other vehicles, such as marine craft and air craft, and non-vehicle apparatus.

### I. Bonding System

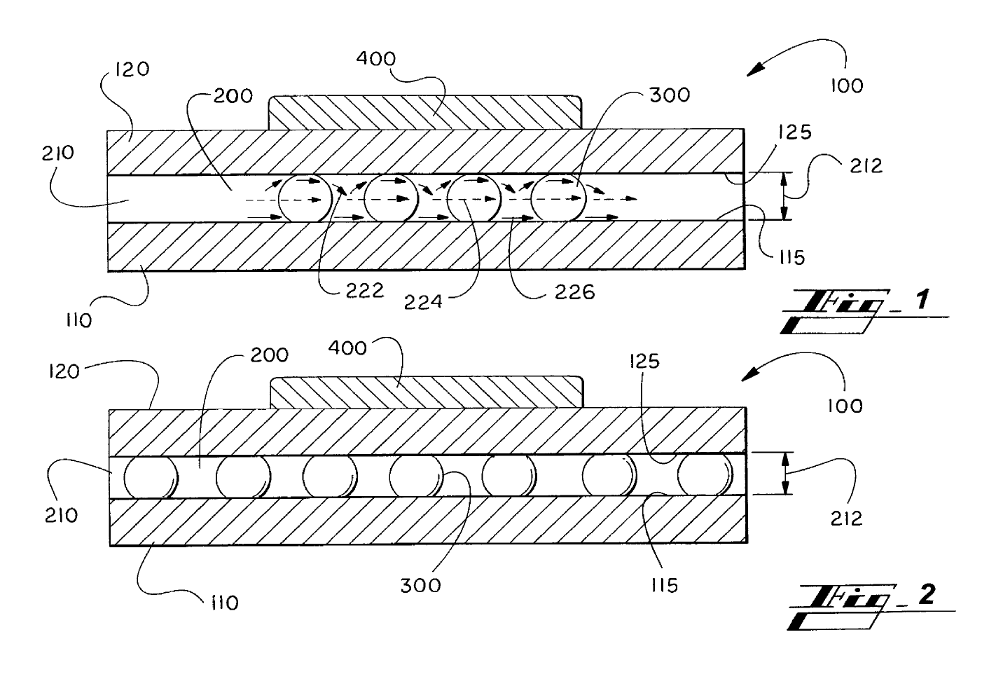

Now turning to the figures, and specifically to the first figure, FIG. 1 illustrates a bonding system identified by reference numeral 100. The bonding system 100 includes a structural adhesive 200 and solder balls 300 which are used to join a first substrate 110 to a second substrate 120.

The substrates 110, 120 are the materials that require bonding to one another.

The substrates 110, 120 may be composed of the same or differing material compositions. Typical substrate material may include materials such as aluminum, steel, magnesium, composite, ceramic, or the like.

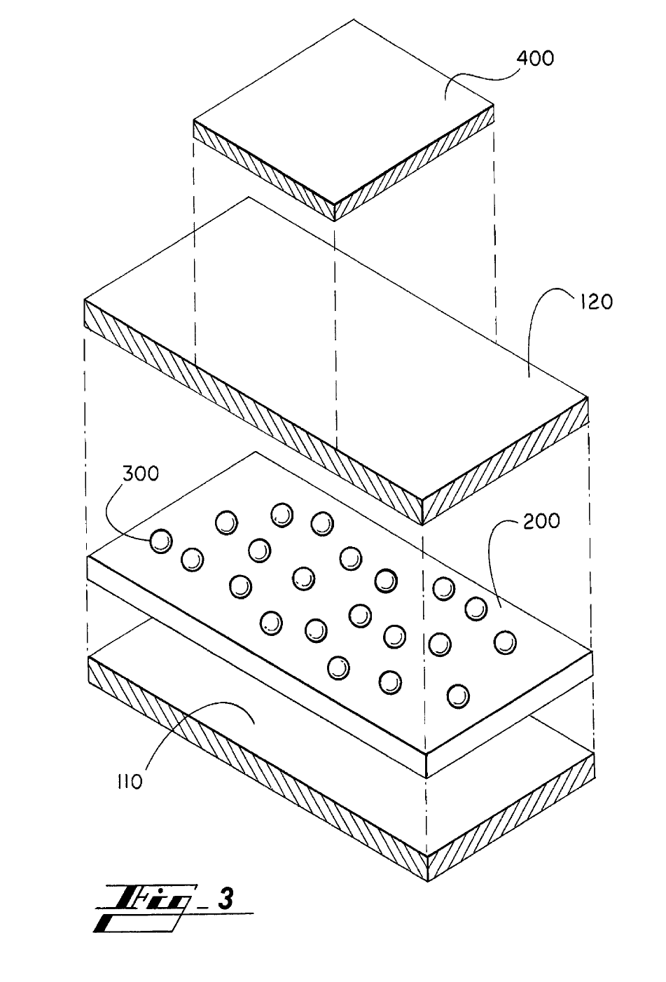

The adhesive 200 is a structural material used to bond a contact surface 115 of the first substrate 110 to a contact surface 125 of the second substrate 120. The adhesive 200 forms a bond line 210 between the contact surfaces 115, 125. In FIGS. 1 and 2, the bond line 210 extends laterally between the substrates 110, 120 and has a thickness 212.

In the present disclosure, the thickness 212 is approximately between about 0.05 to about 0.3 millimeters (mm). As an example, if the contact surfaces 115, 125 are relatively flat, the bond line 210 may have a thickness 212 of approximately 0.2 mm to allow for optimal shear and tensile strength.

In FIG. 1, the solder balls 300,distributed in a defined area,have the ability to bond to one or both of the substrates 110, 120 in the defined area prior to and during manufacturing process (e.g., a curing process). Following the close of the substrates 110, 120 with adhesive 200 between the contacting surfaces 115, 125, the solder balls 300 serve to hold the system 100 together before formation of an adhesive bond in a curing process, for example.

In FIG. 2, incorporating solder balls 300 within a majority of the adhesive 200 also improves fracture resistance of a bond joining the substrates 110, 120. As an example, a fracture threshold in an adhesive without solder balls may occur approximately near 1.8 N/mm, whereas the same fracture in adhesive containing solder balls may occur at approximately near 11.5 N/mm.

The embodiments and the examples provided herein illustrate and describe the solder balls 300 as spherical in shape, which promotes uniform distribution of the solder balls 300 from adjacent solder balls 300 within the defined area or throughout the adhesive 200. However, the solder balls 300 may include other shapes such as, but not limited, to cylinders, rectangles, and the like.

The solder balls 300 can vary in size, shape, and dimension within the system 100. The solder balls 300 should allow contact between at least one of the solder balls and both of the substrates 110, 120 under an applied pressure on either or both substrates 110, 120. For example, if the bond line 210 has a thickness 212 of 0.2 mm, the solder balls 300 may have a dimension of approximately near 0.2 mm or larger, to ensure compression of the solder balls 300 during bonding, which will ensure adequate joining to contact surfaces 115, 125.

The solder balls 300 may be composed of any commercially available material or a custom composition. When at least one of the substrates 110,120 is at least partially composed of metal and/or metal composites, composition materials of the solder balls 300 may include materials such as tin (Sn), lead (Pb), silver (Au), copper (Cu), zinc (Zn), bismuth (Bi), and/or the like. If at least one of the substrates 110,120 is at least partially composed of polymer and/or polymer composites, the solder ball 300 composition may also include polymer materials such as polycarbonate (PC), polyethylene (PE), polypropylene (PP), divinylbenzene (DVB), and/or the like.

In some embodiments, bonding of the solder balls 300 to substrates 110, 120 prior to curing of adhesive 200 may be performed using a spot heating element 400 (seen in FIG. 3). Bonding of the solder balls 300 to the substrates 110, 120 allows the structure and dimensionality of the bondline 212 to maintain its integrity until the adhesive 200 cures during a subsequent operation (e.g., paint).

The heat element 400 can be a localized, heating element used to bond the solder balls 300 to one or both contact surfaces 115, 125. The heat element may be approximately in contact with one or both substrates 110, 120. The heat element 400 can be used to conduct spot soldering for a specific period of time at a temperature conducive for bonding. For example, the spot soldering can occur when the heat element is greater than 200° C. for a short duration of time (e.g., 2 to 5 seconds).

The heat element 400 may include flat or textured and include one or more round or square face(s) in the order of 1 to 500 mm². The tip of the heat element 400 may be constructed with any material that is thermally conductive and can sustain temperature up to 300° C. or above.

In some embodiments, the heat element 400 may be a one-piece tool with a surface transmitting heat toward either substrate 110 or 120, whichever is in contact with the heat element 400. The one-piece heat element 400 may also serve as a compression tool to compress the second substrate 120 against the adhesive 200 and solder balls 300, which compresses against the first substrate 120, or vice versa. When used as a compression tool, the heat element 400 causes the solder balls 300 to ensure contact and bonding with the contact surface 115, 125.

In some embodiments, the heat element 400 may be in the form of two electrical electrodes, at opposite potentials,in contact with both substrates 110, 120 from opposing directions. The substrates 110, 120 and solder balls 300, each having an electrical conductivity, generate enough heat to form spot solders between the substrates 110 and 120, which provides the substrates 110, 120 enough bond force to maintain the dimensionality of the substrates 110, 120 until the adhesive 200 cures during subsequent processing.The two electrical electrodes may also serve as compression tools acting together to compress the system 100, so that the solder balls 300 may bond to the contact surface 115, 125.

Desirable characteristics of the solder ball 300 include, but are not limited to (1) a density conducive for bonding, (2) a temperature conducive for bonding, and (3) increased tensile strength over prior art.

The density should be such that the solder balls maintain their structure when incorporated into the adhesive 200 prior to bonding. The solder balls 300 density can be approximately between about 0.5 and about 15.00 g/cm³. For example, a solder ball containing tin-lead (Sn—Pb) or tin-silver-copper (Sb—Ag—Cu or SAC) may have a density approximately near 7.5 g/cm³, which may provide adequate density for bonding when at least one of the substrates 110,120 is at least partially composed of metal and/or metal composites. As another example, a solder ball containing ethenylbenzene or divinylbenzene (DVB) may have a density approximately near 0.9 g/cm³.

The temperature should be such that the solder balls 300 bond without affecting (e.g., deforming) composition materials of the substrate 110, 120. In some embodiments it is desirable to include a solder ball that has a melting point of less than 200° C. to prevent de-bonding (e.g., fracture) of the solder balls 300 from the contact surfaces 115, 125 and improve fracture resistance of the adhesive 200.

In some embodiments, the solder balls 300 can be composed of materials that are high in strength and bond at a high temperature (e.g., above 200° C.). High temperature solder balls 300 are melted in spot soldering prior to adhesive curing to secure dimensions of the substrates 110, 120 during adhesive curing cycle. These high temperature solder balls are used in the example shown in FIG. 1 where solder balls are located in specific areas that are spot soldered.

In some embodiments, the solder balls 300 can be bonded at a low temperature (e.g., below 200° C.). Low temperature spot soldering maintains structure and dimensionality of the system 100 while the adhesive 200 strengthens during curing. As the temperature rises during curing, the solder balls 300, including those previously spot soldered, melt and bond with one or both of the substrates 110, 120. When the temperature reduces (e.g., returns to ambient temperature), solder bonds are formed throughout the bondline 212 where the solder balls 300 contact at least one of substrates 110 and 120.

In some embodiments, the solder balls 300 may be composed of materials that include different bonding temperatures below and above 200° C.Using a combination of high temperature and low temperature solder balls 300, allows the low and high temperature solder balls 300 under the heat element 400 to bond during spot soldering while allowing low temperature solder balls to bond during the adhesive curing process in other locations within the bondline 212.

Tensile strength of the system 100,as measured under tension forces,should be greater when compared to an adhesive without filler material or an adhesive containing non-bonding filler material. For example, when solder balls 300 are used in conjunction with the adhesive 200, the overall system 100 may have a tensile strength of approximately between about 50 MPa and 150 MPa, whereas an automotive adhesive alone may have a tensile strength of approximately between about 15 MPa and 35 MPa, and an automotive adhesive with glass beads may have a tensile strength of approximately between about 15 MPa and 35 MPa.

In some embodiments, the bond line thickness 212 is such that the solder balls 300 may join to both of the contact surfaces 115, 125 (seen in FIG. 1). Joining the solder balls 300 to both contact surfaces 115, 125 has benefits including promoting a crack that propagates in the adhesive 200 approximately near solder balls 300 according to a fracture path that requires the greatest amount of fracture energy (i.e, the amount of energy required to propagate the crack). The crack may (i) propagate along a pre-identified fracture path 222 (depicted as a series of short solid arrows in FIG. 1), (ii) propagate along a pre-identified fracture path 224 (depicted as a series of dashed arrows in FIG. 1), (iii) propagate along a pre-identified fracture path 226 (depicted as a series of long solid arrows in FIG. 1), or (iv) arrest at the interface of the adhesive 200 and the solder ball 300.

The fracture paths 222, 224, 226 correlate generally to a path of greatest resistance for any fracture. Because the adhesive 200 is generally weaker than the substrates 110, 120 and the solder balls 300, the fracture paths may extend through the adhesive 200 as illustrated by the fracture paths 222, 224 or along one of the contact surfaces as illustrated by the fracture path 226.

When the crack propagates around each solder ball 300, the fracture path 222 is formed along one of contact surfaces 115, 125, as shown in FIG. 1. Although FIG. 1 depicts the fracture path 222 extending around each solder ball 300 toward the first contact surface 115, alternatively, the fracture path 222 could extend around any one or more of the balls 300 toward the second contact surface 125. Although FIG. 1 depicts the fracture path as continuing around each subsequent solder ball 300, in actuality, when the fracture path 222 approaches each subsequent solder ball 300, the fracture path 222 may (i) travel around the solder ball 300, (ii) travel through the solder ball 300, (iii) travel along one of the contact surface 115, 125, or (iv) arrest at the interface of the adhesive 200 and the solder ball 300.

The fracture path 224 is formed when a crack propagates through the solder ball 300 and then propagates into the adhesive 200 prior to reaching a subsequent solder ball 300. Similar to the fracture path 222, when the fracture path 224, reaches each subsequent solder ball 300, the fracture path 224 may (i) travel around the solder ball 300, (ii) travel through the solder ball 300, or (iii) travel along one of the contact surface 115, 125, or (iv) arrest at the interface of the adhesive 200 and the solder ball 300.

The fracture path 226 is formed when a crack propagates around the solder ball 300 and along one of the contact surfaces 115,125. Unlike the fracture paths 222, 224, when the fracture path 226 is formed, the crack continues to propagate along the contact surface 115, 125 where the crack commenced.

Alternately, the crack may arrest at any interface of the adhesive 200 as the solder ball 300 along the paths 222, 224, 226. Arresting of the crack may be highly desired within the system 100 because reduced or eliminated propagation of the crack may prevent failure of the system 100 due to fracture.

In some embodiments, the bond line thickness 212 is such that the solder balls 300 join to only one of the contact surfaces 115, 125. A benefit of restricting solder ball 300 contact to one contact surface 115 or 125 is the ability to join dissimilar substrate materials (e.g., metal material joining with a composite material—e.g,. polymer composite) without compromising the integrity of either substrates 110, 120.

Where the first substrate 110 has a different composition than the second substrate 120, bonding the substrates 110, 120 according to the present technology may have an added benefit of enhanced strength at the bond line 210 compared to prior art. Specifically, e.g., the bond line 210 is stronger with the incorporation of solder balls 300 because the energy required to initiate fracture path propagation around the solder balls 300 is higher than the energy required for fracture path propagation in the adhesive alone or along an adhesive/metal interface.

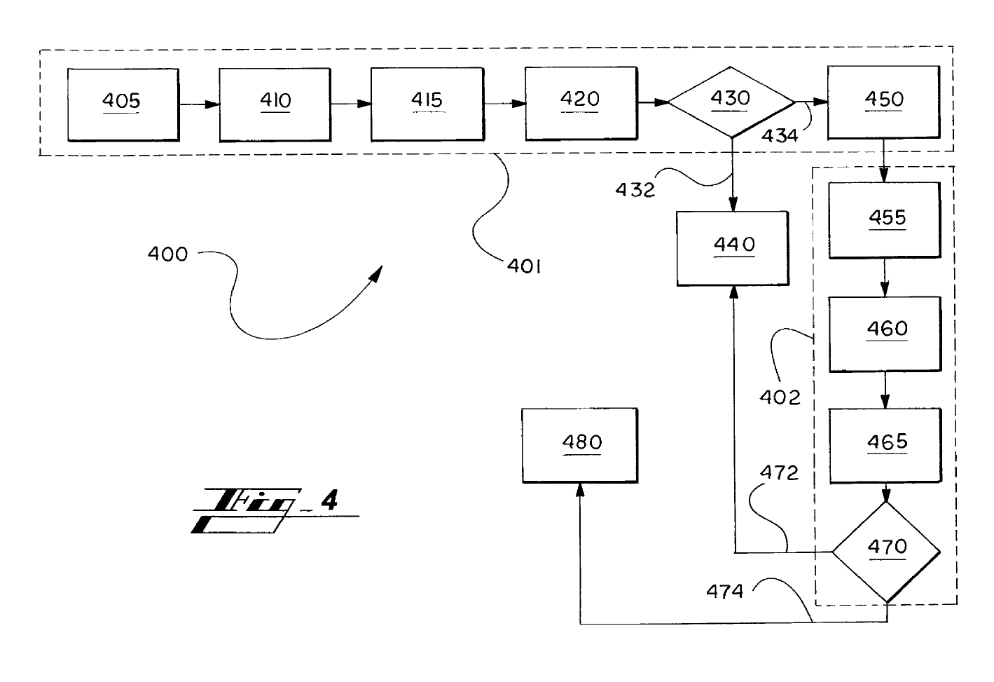

### II. Method of Performing Uniform Distribution—FIGS. 4 and 6 (P027926)

In some embodiments, the solder balls 300 are contained in the adhesive 200 and are dispensed out of a distribution nozzle 205. The dispensing of the solder balls 300 can be monitored according to a sequence 400, which can be monitored with the use of electric conduction, as seen in FIG. 4. A spreading and dispense monitoring method for adhesive and solder balls includes a distribution sequence 401 and an electrical resistance sequence 402. The solder balls 300, composed of materials with electrical conductance, can be electrically conducted to ensure proper contact with the substrates 110 and/or 120, which have another electrical conductance.

In some embodiments, the solder balls 300 are positioned within the adhesive 200 after the adhesive 200 is dispensed out of the nozzle 205 onto the contact surface 115 of the first substrate 110. The positioning of the solder balls 300 can be monitored according to a sequence 400, which can be monitored with the use of electric conduction, as seen in FIG. 4. The method includes a distribution sequence 401 and an electrical resistance sequence 402. The solder balls 300, composed of materials with electrical conductance, can be electrically conducted to ensure proper contact with the substrates 110 and/or 120, which an electrical conductance different from the adhesive 200.

For example, the sequence can be accomplished by a robotic dispensing system. The dispensing system can include a controller 207, discussed below, to monitor inlet and outlet valves for accurate deposition and control of material flow. The dispensing systems can be designed to accurately and quickly dispense the adhesive 200 and the solder balls 300 for application such as, but not limited to,bonding. The dispensing system together can store, using a memory, or the like, dispensing programs created and quickly programs to start a production cycle. Within each dispensing program, the adhesive 200 can be applied at different flow rates to ensure, for example, proper flow of the adhesive 200.

The distribution sequence 401 begins at step 405 with positioning the first substrate 110 to receive the adhesive 200 alone or an adhesive composite 250 including the adhesive 200 and the solder balls 300.

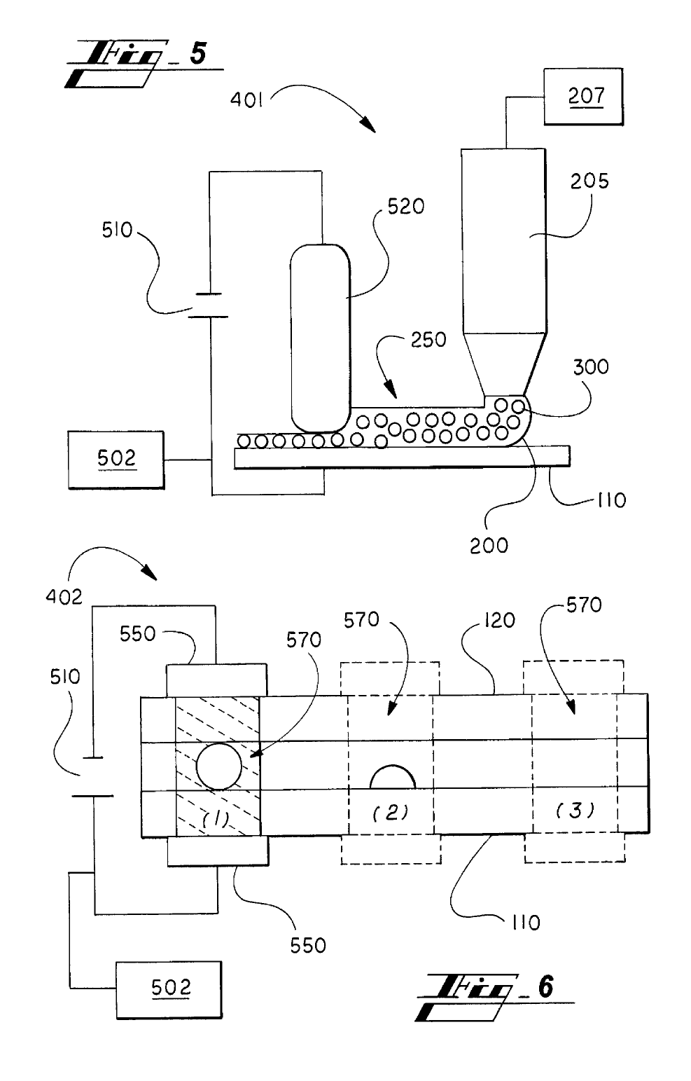

Next, at step 410, an energy storage element 510is attached to the first substrate 110 as well as a conductive spreader 520 as seen in FIG. 5.

The storage element 510, can be any conventional storage device known in the art, such as but not limited to capacitor, battery, or the like. The storage element 510 should be able to store enough energy to operate the components (e.g., conductive spreader 520) associated with measuring electrical resistance in the system 100.

Next, at step 415, the energy storage element 510 is activated. When the element 510 is activated, electrical current flows through the element 510 to the first substrate 110 and the conductive spatula 520.

In some embodiments, the storage element 510, can be an activated through a controller 502 containing a processor (not shown).

The controller 502 may be a microcontroller, microprocessor, programmable logic controller (PLC), complex programmable logic device (CPLD), field-programmable gate array (FPGA), or the like. The controller may be developed through the use of code libraries, static analysis tools, software, hardware, firmware, or the like. Any use of hardware or firmware includes a degree of flexibility and high-performance available from an FPGA, combining the benefits of single-purpose and general-purpose systems. After reading this description, it will become apparent to a person skilled in the relevant art how to implement the technology using other computer systems and/or computer architectures.

The controller 502may include structure such as, but not limited to, processors, data ports, memory with categories of software and data used in the energy storage 510, and the like.

Next, at step 420, a distribution nozzle 205, seen in FIG. 5, is energized. When the nozzle 205 is energized the adhesive composite 250 is allowed to flow onto the first contact surface 115 of the first substrate 110.

The nozzle 205 can include any conventional nozzle suitable for distribution of the adhesive composite 250. For example, the nozzle 205 can be a portion of a robotic adhesive application. Such a robotic application can include a controller equipped with a processor (not shown) to monitor inlet and outlet valves for accurate deposition and control of material flow.

In some embodiments, the distribution nozzle 205 includes a controller 207. The controller 207 can be of similar structure and function as the controller 502.

Next, at step, 430, the applicator determines if a fault condition exists. Fault condition can include, for example, adhesive composite 250 flowing improperly, or not at all, from the nozzle 205. If the adhesive composite 250 is not flowing (e.g., path 422), the sequence may display an indicator at step 440. The indicator can be any alert, such as but not limited to warnings, displays, alarms or the like, which are communicated to the robotic application or an operator.

As another example, a fault condition can include a scenario where an insufficient amount of solder balls 300 are present within the adhesive 200. If an insufficient amount of solder balls 300 is present (e.g., path 422), the sequence may display an indicator at step 440.

A sufficient amount of solder balls 300 may be determined when the electrical resistance is determined at step 465 below. Indicators can also include reset switches to reactive detectors 550 once the fault condition has been corrected. Additionally, a reset switch to reactivate detectors once fault condition (e.g., adhesive distribution) has been corrected.

If no faults are detected (e.g., path 424), the adhesive composite 250 is smoothed using the conductive spreader 520at step 450.

The conductive spreader 520 contains an electric charge from the energy storage element 510, which creates and applies pressure and electrical conductance to the composite mixture which sends electrical conductance through the solder balls 300. The conductive spatula 520 only needs to apply enough electricity and pressure to the adhesive composite 250 to ensure sufficient contact between the adhesive composite 250 and the first substrate 110 to retain and properly spread the adhesive composite 250 on the first substrate 110.

The electrical resistance sequence beings at step 455 with positioning the second substrate 120 on top of the composite of adhesive 200 and solder balls 300.

Next, at step 460, one or more resistance detectors 550, is attached to the both substrates 110 and 120, as seen in FIG. 6.

The detectors 550 can be positioned on an outer edge of the substrates 110, 120 to cause an in-line electrical resistance 570 through the first substrate 110, through the solder ball 300 (by-passing the non-conductive adhesive 200), and finally aligned with the second substrate 120.

Next, at step 465, the electrical resistance 270 generated between the detectors 550 is measured. When the detectors 550 are in positioned and electrical resistance 570 is passed through the system 100, detect value of electrical resistance as an indicator of the degree of solder bonding to both substrates 110, 120. Additionally, the detectors 550 that can work as spot soldering or resistance spot welding electrodes.

Next, at step 470, the sequence 402 determines if the electrical resistance is sufficient for the particular application. FIG. 5 illustrates three areas, which are scanned by the detectors 550 to determine electrical resistance 570 within the scanned area. Area (1) illustrates a solder ball 300 joined to both substrates 110, 120; area (2) illustrates a solder ball 300 bonded to only one substrate, specifically, substrate 120 in FIG. 4;and area (3) illustrates no solder ball or an insufficient amount of adhesive.

In area (1), the solder ball 300 has a bond with both substrates 110, 120, which will provide a level of electrical resistance. In area (2), the scanned area the solder ball 300 only has a bond with the first substrate 110, which will provide a larger level of electrical resistance than scenario (1). In area (3), the solder ball 300 does not include a solder ball 300, which will provide no electrical resistance because no current is present.

In some embodiments, it is desirable to have the minimum resistance provided within scanned area. However, a higher level of resistance may be acceptable in particular situation (e.g., when the substrates 110 and 120 are composed of different materials).

If one or more of the scanned area does not meet the desired electrical resistance (e.g., path 472), the sequence 400 may display an indicator after scanning areas (2) and/or (3) an indicator can be displayed at step 440. A lack of solder bonds or adhesive bonding can cause inferior bond strength, therefore as a means to repair, the same electrical resistance detecting electrodes may be used to establish a resistance spot weld by increasing pressure applied on the substrates 110, 120 by the electrodes and passing through a large amount of electrical current between the substrates 110, 120.

If the scanned areas meet the desired electrical resistance (e.g., path 474), the sequence 400 passes the scanned area to a future stage within the manufacturing process (e.g., curing) at step 480.

### III. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. A bonding system (100), comprising:
a first substrate (110);
a second substrate (120), at least partially in contact with a heating element (400);
an adhesive (200), in contact with a first contact surface (115), of the first substrate (110), and a second contact surface (125), of the second substrate (120); and
a plurality of solder balls (300) positioned in the adhesive (200) in contact with the first contact surface (115) in a location to receive thermal energy from the heating element (400).

2. The system of claim 1, wherein the heating element (400) produces thermal energy to a localized area of the second substrate (120).

3. The system of claim 1, wherein the plurality of solder balls (300)bonds to the first substrate (110) at a temperature conductive to thermal energy produced by the heating element (400).

4. The system of claim 1, wherein at least one of plurality of solder balls (300) bonds to the first substrate (110) at a temperature other than the thermal energy produced by the heating element (400).

5. The system of claim 1, wherein the plurality of solder balls (300) are positioned in a distribution (i) arresting crack propagation or (ii) promoting crack propagation along a path(232, 234) requiring, in at least one section of the system (100), the greatest amount of fracture energy.

6. The system of claim 1, wherein one or more of the plurality of solder balls (300) are further positioned in contact with the second contact surface (125).

7. The system of claim 6, wherein the plurality of solder balls (300) bonds to the first substrate (110) and the second substrate (120) at a temperature conductive to thermal energy produced by the heating element (400).

8. The system of claim 6, wherein at least one of plurality of solder balls (300) bonds to the first substrate (110) and the second substrate (120) at a temperature other than the thermal energy produced by the heating element (400).

9. The system of claim 6, wherein the plurality of solder balls (300) are positioned in a distribution (i) arresting crack propagation or (ii) promoting crack propagation along a path (222, 224, 226) requiring, in at least one section of the system (100), the greatest amount of fracture energy.

10. A bonding system (100), comprising:
a first substrate (110);
a second substrate (120), at least partially in contact with a heating element (400);
an adhesive (200), in contact with a first contact surface (115), of the first substrate (110), and a second contact surface (125), of the second substrate (120); and
a plurality of solder balls (300), of one or more bonding temperatures, positioned throughout the adhesive (200) in contact with the first contact surface (115) at least one of the plurality of solder balls (300) positioned to receive thermal energy from the heating element (400).

11. The system of claim 10, wherein the heating element (400) produces thermal energy to a localized area of the second substrate (120).

12. The system of claim 10, wherein the plurality of solder balls (300) bonds to the first substrate (110) at a temperature conductive to thermal energy produced by the heating element (400).

13. The system of claim 10, wherein at least one of plurality of solder balls (300) bonds to the first substrate (110) at a temperature other than the thermal energy produced by the heating element (400).

14. The system of claim 10, wherein one or more of the plurality of solder balls (300) are further positioned in contact with the second contact surface (125).

15. The system of claim 14, wherein the plurality of solder balls (300) bonds to the first substrate (110) and the second substrate (120) at a temperature conductive to thermal energy produced by the heating element (400).

16. The system of claim 14, wherein at least one of plurality of solder balls (300) bonds to the first substrate (110) and the second substrate (120) at a temperature other than the thermal energy produced by the heating element (400).

17. A method, to produce a solder-reinforced adhesive bond between a first substrate (110) and second substrate (120), comprising:
applying, on a first contact surface (115) of the first substrate (110), an adhesive composite (250) including an adhesive (200) and a plurality of solder balls (300), such that at least one of the plurality of solder balls (300) is in contact with the first contact surface (115);
connecting, to a portion of the adhesive composite (250) opposite the first contact surface (115), a second contact surface (125) of the second substrate (120); and
applying, to a surface of the first substrate (120), opposite the first contact surface (115), thermal energy from a heating element (400) such that at least one of the plurality of solder balls (300) reaches a solder-ball bonding temperature.

18. The method of claim 17, wherein the heating element (400) produces thermal energy to a localized area of the second substrate (120), opposite the second contact surface (125).

19. The method of claim 17, wherein the plurality of solder balls (300) bonds to the first contact surface (115) or the second contact surface (125) at a temperature conductive to thermal energy produced by the heating element (400).

20. The system of claim 17, wherein at least one of plurality of solder balls (300) bonds to the first contact surface (115) or the second contact surface (125) at a temperature other than the thermal energy produced by the heating element (400).
